(19) United States
(12) Patent Application Publication
(10) Pub. No.: US 2002/0171523 A1
(43) Pub. Date: Nov. 21, 2002

(54) IGNITION OIL

(76) Inventors: YOSHIHIRO SHIMOIDE, TOKAI-CITY (JP); KAZUHIDE KAWAI, KARIYA-CITY (JP)

Correspondence Address: NIXON & VANDERHYE PC, 1100 NORTH GLEBE ROAD 8TH FLOOR, ARLINGTON, VA, 222014714

(21) Appl. No.: 09/459,643

(22) Filed: Dec. 13, 1999

(30) Foreign Application Priority Data
Jan. 11, 1999 (JP) 11-3575

(51) Int. Cl. H01F 27/02

(52) U.S. Cl. 336/90

(57) ABSTRACT

In order to prevent a crack of plastic parts caused by a shrinkage force of a resin filler filled in an ignition coil casing, a cylindrical coil casing houses a primary coil and a secondary coil concentrically, and the resin filler such as epoxy resin is filled in the coil casing to insulate between the parts in the coil casing and to fix the parts. A ring-shaped partition member is provided at the upper portion in the coil casing to separate the resin filler locating above the primary coil and the secondary coil inside and outside. The partition member is made of a resin whose adhesive strength against the resin filler is weak, such as polypropylene (PP). The partition member reduces the shrinkage force between the outside resin filler and the inside resin filler, and prevents a crack of plastic parts, such as the secondary spool.

### CROSS REFERENCE TO RELATED APPLICATION

This application is based upon and claims priority from Japanese patent application No. Hei 11-3575, filed Jan. 11, 1999, the entire contents of which are incorporated herein by reference.

### BACKGROUND OF THE INVENTION

1. Field of the Invention

The present invention relates to an ignition coil, such as a stick-type ignition coil, which is installed in a plug hole for each cylinder of an engine.

2. Description of Related Art

One type of known stick-type ignition coil is filled with epoxy resin to insulate and fix a primary winding, a secondary winding and a cylindrical core disposed in a cylindrical coil casing.

The epoxy resin to be filled in the coil casing shrinks when it is hardened after filling. Accordingly, a stress caused by the hardening and shrinkage of the epoxy resin is applied to the plastic parts in the coil casing such as a secondary spool, and the stress remains as it is. Furthermore, the stress applied to the plastic parts may be increased when the epoxy resin is cooled and shrinks after the engine stops if the ignition coil is mounted on the engine. Accordingly, a crack on the plastic parts may be caused by the shrinkage of the epoxy resin, and such crack may decrease the insulation performance.

Especially, an outside dimension of a stick-type ignition coil is regulated by an inside dimension of a plug hole. Thus, the plastic spool has a reduced thickness to obtain a winding space for the coil. Accordingly, mechanical strength of the spool is relatively weak, and an allowable stress of the spool against the shrinkage of the epoxy resin is relatively small. Therefore, it is necessary to reduce the shrinkage force of the epoxy resin applied to the spool in order to prevent the crack of the spool.

Further, the shrinkage force of the epoxy resin applied to the secondary spool locating inner than the primary spool tends to be greater than that applied to the primary spool. Accordingly, the crack is likely to be generated on the secondary spool.

### SUMMARY OF THE INVENTION

The present invention is made in light of the foregoing problem, and it is an object of the present invention to provide an ignition coil which prevents a crack of a part of the ignition coil caused by a shrinkage force of filling resin and which improves the insulation reliability.

According to an ignition coil of the present invention, the ignition coil includes a partition member provided in an upper portion of a coil casing for dividing a resin filler locating above a primary coil and a secondary coil into an inside and an outside. Accordingly, the partition member reduces the shrinkage force between the outside resin filler and the inside resin filler. Thus, stress of plastic parts caused by the shrinkage force is reduced, and a crack of the plastic parts is prevented, and the insulating reliability is improved.

According to another aspect of the present invention, if the partition member is made of made of a material whose adhesive strength against the resin filler is substantially weak such that each of the resin filler and the partition member is capable of expanding and shrinking independently. Accordingly, the resin filler is easily peeled from the partition member when the resin filler shrinks or expands, thereby reduces stress applied to the plastic parts.

### BRIEF DESCRIPTION OF THE DRAWINGS

Other features and advantages of the present invention will be appreciated, as well as methods of operation and the function of the related parts, from a study of the following detailed description, the appended claims, and the drawings, all of which form a part of this application. In the drawings:

FIG. 1 is a longitudinal sectional view of an ignition coil according to a first embodiment of the present invention;

FIG. 2 is an enlarged top plan view of the ignition coil according to the first embodiment of the present invention; and

FIG. 3 is an enlarged top plan view of the ignition coil according to a second embodiment of the present invention.

### DETAILED DESCRIPTION OF PREFERRED EMBODIMENTS

Embodiments of the present invention will be described hereinafter with reference to the drawings.

(First Embodiment)

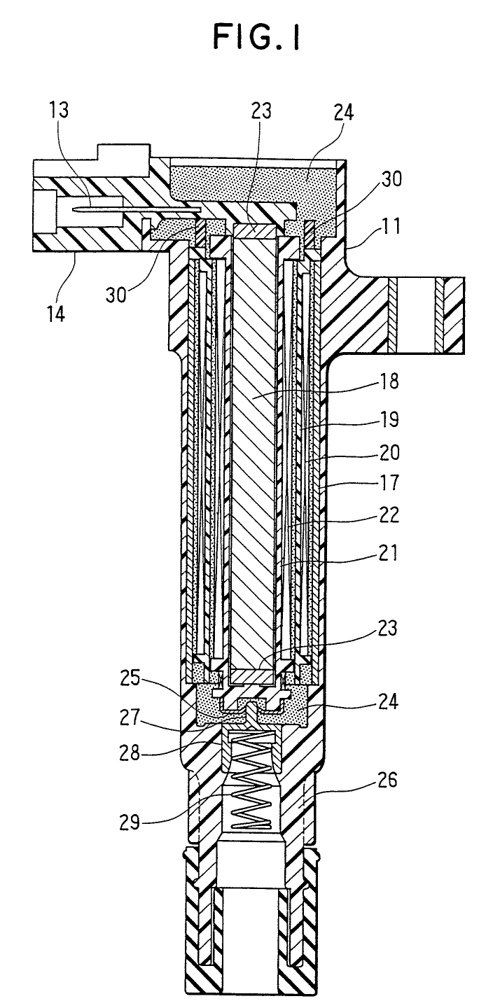

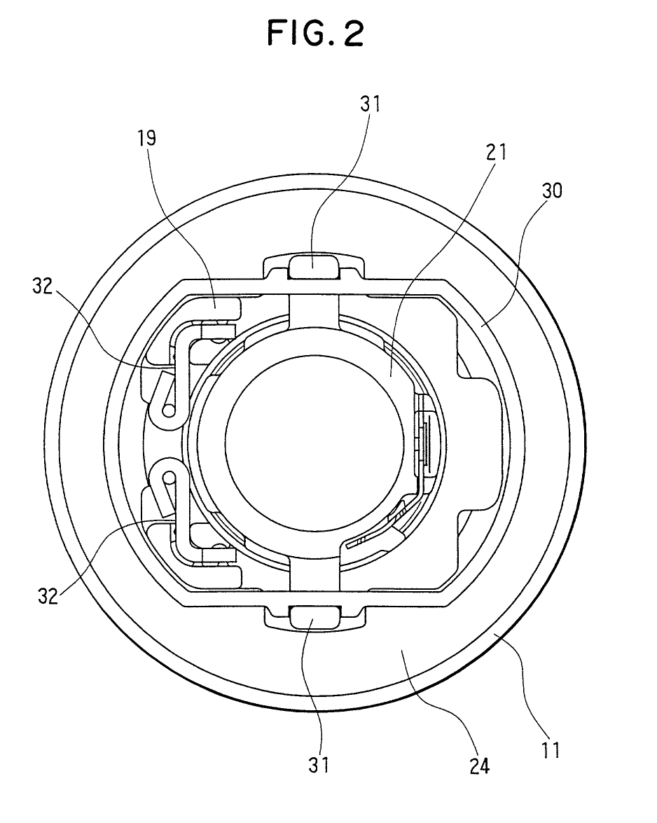

A first embodiment of the present invention is shown in FIGS. 1 and 2.

A cylindrical coil casing 11 is made of insulating resin. A connector pin 13 is inserted in and molded with a connector housing 14. The connector housing 14 is mounted on an upper end of the coil casing 11 by press fitting. A cylindrical central core 18 and a cylindrical outer core 17 are concentrically housed in the coil casing 11.

A primary coil 20, wound around a cylindrical primary spool 19 made of an insulating resin, is housed inside the cylindrical outer core 17. A secondary coil 22, wound around a cylindrical secondary spool 21 made of an insulating resin, is housed inside the primary spool 19. A terminal plate 25 is attached to the bottom end of the secondary spool 21. one end of the secondary coil 22 is connected to the terminal plate 25.

The central core 18 is housed in the secondary spool 21 having a bottom wall. A pair of cushions 23 are disposed at the top and bottom ends of the central core 18. The cushion 23 is a cushioning material to prevent the central core 18 from excessive stress, and is made of a heat resistance elastic material such as a sponge and an elastomer which also prevent magneto striction. Furthermore, thermosetting resin, such as an epoxy resin, is filled in the coil casing 11 by vacuum filling as an insulating resin filler 24.

A high voltage tower portion 26 is unitarily formed with a lower end of the coil casing 11. A terminal cup 28 is unitarily formed with a high voltage terminal 27 by placing the high voltage terminal 27 upwardly. At the center of the top portion of the high voltage tower portion 26, the terminal cup 28 is inserted and molded or press fitted such that the high voltage terminal 27 contacts the terminal plate 25 to maintain the electricity conducting state. When the high voltage tower portion 26 is inserted in an ignition plug hole (not shown) and is press fitted in an upper portion of a spark plug (not shown), a conductive spring 29 latched in the terminal cup 28 contacts a terminal of the spark plug. Accordingly, one end of the secondary coil 22 is electrically connected to the terminal of the spark plug via the terminal plate 25, high voltage terminal 27, terminal cup 28 and spring 29.

A main feature of the first embodiment of the present invention is to provide a partition member 30 to separate the inner side from the outer side of the resin filler 24 filled above the primary coil 20 and the secondary coil 22. The partition member 30 is formed in a ring shape and is made of a resin whose adhesive strength against the resin filler 24 (epoxy resin) is weak, such as polypropylene (PP), polyphenylene sulfide (PPS) and polybutylene terephtalate (PBT).

Instead of using such resin, silicon tape and the like, whose adhesive strength against the resin filler 24 is weak, may be attached on the surface of the partition member 30. Alternatively, the surface of the partition member 30 may be coated to decrease the adhesive strength against the resin filler 24.

As shown in FIG. 2, the partition member 30 is latched and held by a pair of joints 31 unitarily formed with the upper end portion of the secondary spool 21, and the resin filler 24 is filled under such condition. The primary spool 19, a terminal 32 of the primary coil 20, and the secondary spool 21 are provided inside the partition member 30.

Generally, a shrinkage force of the resin filler filled in the coil casing becomes greater when the thickness of the resin filler increases. Inside the coil casing, the thickest portion of the resin filler is locating above the first and secondary coils. Accordingly, the shrinkage force of the resin filler becomes greater at the upper portion of the coil casing. According to the first embodiment of the present invention, since the ring-shaped partition member 30 is provided in the upper portion of the coil casing 11, the partition member 30 divides the resin filler 24 at the top portion in the coil casing 11 between the inside and the outside, thereby preventing the shrinking influence of the outside resin filler 24, and thereby reducing the shrinkage force of the inside resin filler 24. Furthermore, since the partition member 30 is made of the resin whose adhesive strength is weak against the resin filler 24, the resin filler 24 is apt to peel from the partition member 30 because of the shrinkage force of the resin filler 24. Accordingly, the shrinkage force of the resin filler 24 outside the partition member 30 is effectively released, and the shrinkage force of the resin filler 24 inside the partition member 30 is effectively reduced. Thus, the stress, applied to plastic parts such as the primary spool 19 and the secondary spool 21 located inside the partition member 30, is effectively reduced, and a crack of the plastic parts is prevented, and the insulation reliability is improved.

Furthermore, since the partition member 30 is an independent part, the partition member 30 is formed by cheap resin whose adhesive strength against the resin filler 24 is weak. Thus, the crack prevention by the partition member 30 is improved with lower cost.

(Second Embodiment)

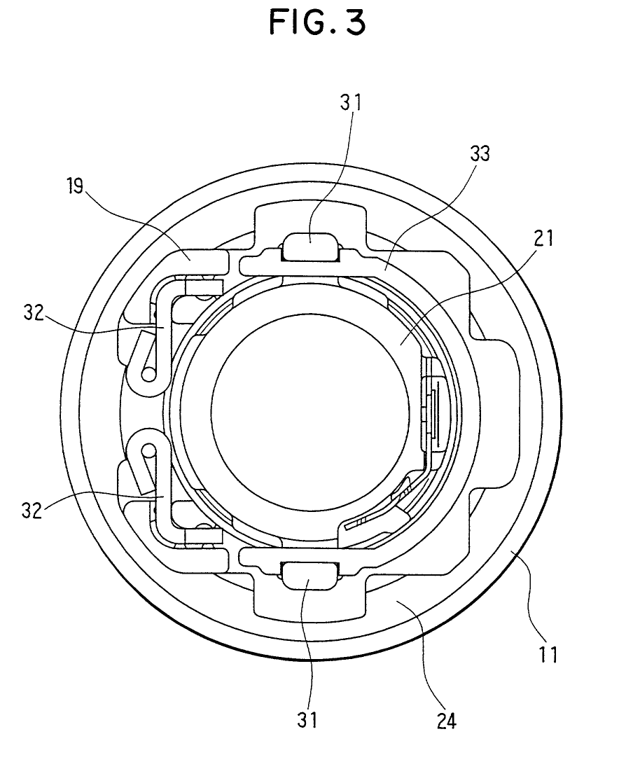

In a second embodiment of the present invention shown in FIG. 3, the present invention is applied to an ignition coil which has a narrower space around the terminal 32. In this embodiment, components which are substantially the same as those in the first embodiment are assigned the same reference numerals.

In the second embodiment, a U-shaped separation member 33 is formed by a resin whose adhesive strength against the resin filler 24 (epoxy resin) is weak such that the separation member 33 and the terminal 32 form a ring-like shape. The partition member 33 is latched and held by a pair of joints 31 unitarily formed with the upper end portion of the secondary spool 21, and the resin filler 24 is filled under such condition. Other structures are the same as those in the first embodiment.

According to the second embodiment of the present invention, the terminal 32 as well as the partition member 33 divides the resin filler 24 into inside and outside. Accordingly, the similar effect described in the first embodiment is obtained even if there is no space for the separation member 33 around the terminal 32.

Although each of the partition members 30 and 33 is an independent part in the first and second embodiments, they may be unitarily formed with other plastic parts such as the connector housing 14. Further, the partition member maybe formed in a shape other than the ring shape.

Furthermore, various modifications, such as providing an igniter above the partition member 30 or 33, are applicable to the present invention.

Although the present invention has been described in connection with the preferred embodiments thereof with reference to the accompanying drawings, it is to be noted that various changes and modifications will be apparent to those skilled in the art. Such changes and modifications are to be understood as being included within the scope of the present invention as defined in the appended claims.

What is claimed is:

1. An ignition coil comprising:
a pipe-shaped coil casing;
a primary coil housed in said coil casing;
a secondary coil housed in said coil casing and disposed concentrically with said primary coil;
an insulating resin filler filled in said coil casing such that a part of said resin filler locates above said primary coil and said secondary coil; and
a partition member provided in an upper portion of said coil casing for dividing said resin filler locating above said primary coil and said secondary coil into an inside and an outside.

2. An ignition coil as in claim 1, wherein said partition member is made of a material whose adhesive strength against said resin filler is substantially weak such that each of said resin filler and said partition member is capable of expanding and shrinking independently.

3. An ignition coil as in claim 1, wherein said partition member is formed in a shape of a ring.

4. An ignition coil as in claim 1, wherein:
the ignition coil includes a terminal for said primary coil at said upper portion of said coil casing; and
said partition member and said terminal are disposed to form a ring-like shape.

5. An ignition coil as in claim 1, wherein said partition member is formed as an independent part.

6. An ignition coil as in claim 1, wherein said partition member is made of a material such that said resin filler peels from said partition member when said resin filler changes its volume.

7. An ignition coil as in claim 1, wherein said partition member reduces a shrinkage force of said resin filler.

8. An ignition coil as in claim 1, wherein:
said resin filler is made of an epoxy resin; and
said partition member includes at least one of polypropylene (PP), polyphenylene sulfide (PPS) and polybutylene terephtalate (PBT).
